(19) United States
(12) Patent Application Publication
(10) Pub. No.: US 2006/0040394 A1
(43) Pub. Date: Feb. 23, 2006

(54) Method of searching for and generating polymrophs of a substance

(76) Inventors: Poongunran Muthukumaran, Worcester, MA (US); Lalit Chordia, Pittsburgh, PA (US)

Correspondence Address: LALIT CHORDIA;THAR TECHNOLOGIES, 730 WILLIAM PITT WAY, PITTSBURGH, PA, 15238, US

(21) Appl. No.: 10/837,876

(22) Filed: May 3, 2004

Related U.S. Application Data
(60) Provisional application No. 60/467,537, filed on May 2, 2003.

(51) Int. Cl. G01N 21/41

(52) U.S. Cl. 436/4; 422/130

(57) ABSTRACT

The present invention provides a method and apparatus for producing polymorphs of a desired substance providing a plurality of enclosed spaces. The temperature and pressure of the enclosed spaces can be controlled. Various crystal identification means can be used to identify the polymorphic form of the solidified substance.

### CROSS-REFERENCE TO RELATED APPLICATION

This application claims priority to U.S. provisional patent application Ser. No. 60/467537 filed May 2, 2003, and U.S. provisional patent application Ser. No. 60/559,896 filed on Apr. 6, 2004 by Muthukumaran et al, teachings of which are incorporated herein by reference.

### BACKGROUND OF THE INVENTION

High-throughput screening is a technique used in a variety of fields including drug discovery. It is a process in which a large number of compounds are tested at one time for interaction with a specific target. Examples of interactions include various types of binding and biological activity against a target. Sophisticated systems can screen over 100,000 per day, allowing for a fast way to eliminate compounds that are not potential drug candidates. Similar high throughput techniques are used in systems where an experimental design can be performed to evaluate the effects of the variables on one or more specific characteristics.

In many instances, the same chemical compound can possess multiple crystalline structures. The term polymorphism is used to refer to this phenomenon and has been found to be increasingly important in catalytic, cosmetic, pharmaceutical and other applications. Drug research and development greatly depends on which polymorph of a drug substance is being used in the process because polymorphs of a substance can exhibit varying physical properties. Such varying properties may include:
1. Solubility
2. Melting point
3. Dissolution rate
4. Chemical Stability
5. Physical Stability
6. Powder flowability
7. Compaction
8. Particle Morphology
9. Hygroscopic behavior

Polymorph screening has been previously demonstrated and can be accomplished by altering parameters such as temperature, pressure, and crystallization agent and solvent concentrations. However, these screening processes also need to be efficient, especially when the compounds involved are pharmaceutical in nature. Drug compounds can be very costly, so keeping quantities amounts for screening experiments small is critical. Multi-well plates can be employed in order to be enable screening of a large number of crystallization conditions with minimal quantities of a desired drug substance.

Recently, several research groups have published results for the high-throughput screening of various compounds, namely proteins. Juárez-Martinez et al. (2002) Anal. Chem. 74:3505-3510 designed a micromachined miniaturized array of chambers for protein crystallization screening using hen egg white lysozyme as a model. The resulting crystals were analyzed using X-ray diffraction. Karain et al. (2002) Acta Cryst. D58:1519-1522 reported a system which was automated to screen protein crystals via X-ray diffraction. A semi-automatic system for protein crystallization was also described by Watanabe et al. Acta Cryst. D58:1527-1530. Finally, Heinemann et al. Acc. Chem. Res. 36:157-163 discussed the facilities and methods used for the high-throughput crystal structure analysis of human proteins. Proteins were first purified using affinity chromatography and then a robotic high-throughput screening system was built with the capacity to handle 960,000 experiments simultaneously. X-ray diffraction was used to analyze the crystals.

In addition to the aforementioned published journal articles, several patents and patent applications have also addressed this issue. In 1995, WO 95/01221 disclosed a method and apparatus for the formation of particles using an antisolvent process in which different polymorphs could be selectively formed. For example, when the antisolvent (carbon dioxide) was at 250 bar and 90° C., one polymorph was formed. However, at 300 bar and 45° C., a completely different polymorph resulted. This patent was thus able to demonstrate that variation of experimental parameters could indeed produce various polymorphs. WO 02/20538 also teaches an unexpected finding of a way to produce a polymorph with a high level of purity by controlling the amount of water in the solvent. Edwards et al (2001) J. Pharm. Sci, 90(8), 1115, Kordikowski et al.(2001) Pharm. Res,18(5), 682, Beach et al. Org. Proc. Res.Dev (1999) 3,370, Tong et al.(2001) Pharm. Res 18(6) 852 and Hong et al.Pharm. Res (2002) 19(5) 640 describe the background for the present invention where several polymorphs were obtained by changing certain conditions.

Various methods for the high-throughput screening of crystalline materials have been discussed in patent literature. Notable examples are WO 02/082047, WO 99/59716, WO 00/67872, WO 02/42731, US 2002/0177167, and US 2003/0061687. WO 01/82659 specifically discloses a system and method for the high-throughput screening of polymorphs. The system is comprised of an X-ray source which can emit a beam. An automatic sample changer allows for each sample to be positioned in the path of the beam. Once the sample is irradiated, a detector is used so the sample can be analyzed further. The automatic sample changer then removes the sample and inserts a new one in the path of the beam.

High-throughput crystallization and screening of biomolecules is discussed in WO 02/066713 and US 2002/0191048. The patents disclose a method in which fluid drops are ejected acoustically and subsequently form arrays that can be crystallized. The method can allow for the formation of combinatorial libraries of biomolecules, such as proteins. Additionally, small volumes of fluid are employed so the process can proceed more efficiently. Similarly, US 2003/0059522 also discloses the preparation of arrays of peptides using acoustic energy. The fluids that can be used for this invention include a wide array of compounds, such as organic solvents, lipidic liquids, and supercritical fluids, providing that they can solubilize the given compound. The present invention differs from these in the way fluids are used: the present invention uses an antisolvent technique for crystallizing or precipitating a droplet or a cluster of droplets to form various polymorphs.

The screening of polymorph libraries via X-ray diffraction is disclosed in U.S. Pat. No. 6,507,636. Multi-well plates are used to create arrays that can be subjected to analysis for the potential discovery of new crystalline structures. Crystallization is performed in the wells of the plate, followed by the removal of a base plate. An X-ray beam is then scanned over the base plate and the crystals can then be analyzed. Automation in supercritical fluid extraction has been disclosed in U.S. Pat. No. 5,866,004, the teachings of which set the background for the engineering structures needed for certain embodiments of the present inventions.

### BRIEF DESCRIPTION OF THE DRAWINGS

FIG. 1 is a schematic representation of the one of the embodiments of the present invention

FIG. 2 illustrates the bottom cap of the battery of enclosed spaces referred in the present invention

FIG. 3 illustrates the same element referred in FIG. 2 with a series of enclosed spaces

FIG. 4 illustrates another embodiment in the present invention with enclosed spaces taking any shape or form

FIG. 5 illustrates the embodiment with antisolvent directly injected into the dispersion phase

FIG. 6 is a schematic representation of the polymorph screening system which uses a compressed antisolvent.

FIG. 7 is a schematic representation of the polymorph screening system which uses a compressed antisolvent and a co-antisolvent.

FIG. 8 is a schematic representation of the polymorph screening system which uses a compressed antisolvent and a separate pump for the solution to enter the chamber.

FIG. 9 is a schematic representation of the polymorph screening system which uses a compressed antisolvent and a co-antisolvent and a separate pump for the solution to enter the chamber.

### SUMMARY OF THE INVENTION

The present invention provides a method and apparatus for producing polymorphs of a desired substance comprising the steps of providing a plurality of enclosed spaces, transferring the dispersions of the desired substance in at least one solvent into different enclosed spaces, and applying a compressed antisolvent to the enclosed spaces to solidify the desired substance. The temperature of the enclosed spaces can be controlled and a crystal identification means is used to identify the polymorphic form of the solidified substance. The dispersion is atomized into the enclosed spaces and the transfer of dispersion and application of antisolvent are carried out simultaneously. The solvents are aqueous based, organic based, or a combination of organic and aqueous based. The plurality of enclosed spaces comprises well plates or a battery of high pressure vessels. The temperature is controlled through electric heaters, magnetic heaters, or zone heaters. Control of the rate of application of antisolvent is provided and the antisolvent is added directly into the dispersion phase. The pressure of the enclosed spaces can also be varied. The antisolvent is selected as one or more combinations from a group consisting of methanol, ethanol, dimethylsulfoxide, tetrahydrofuran, N,N dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isbutyl acetate, isopropyl acetate, 2-methyl-1 propanol, pentane, 1-pentanol, 1-propanol, and 2-propanol, ethane, propane, carbon dioxide, nitrous oxide, butane, isobutene, sulfur hexafluoride. However, the antisolvent is typically carbon dioxide, a hydrofluorocarbon or a chlorofluorocarbon. The crystal structure identification means is X-ray diffractometry, thermomicroscopy, solid state nuclear magnetic resonance spectroscopy, infrared or near-infrared spectroscopy, differential scanning calorimetry, or raman spectroscopy. The bottom of the enclosed space holds the solidified material and at least one side of the enclosed spaces is made of crystal identification means transparent material. The crystal structure identification is performed either while or after the dispersion is solidified. The crystal structure identification is performed after the enclosed space is depressurized. The crystal structure identification is performed after the solids are removed from the enclosed space. The transfer of dispersion is accomplished through a small dispensing means. The small dispensing means can handle microliter, nanoliter, picoliter, or femptoliter quantities.

### DETAILED DESCRIPTION OF THE INVENTION

Definitions:

“Polymorph” means Different crystalline or non-crystalline structures of a solid material. It includes the amorphous form and various solvate, hydrate forms commonly referred to as pseudo polymorphs. Different polymorphs have different free energy associated with them.

“Metastable polymorph” is a polymorph that is not stable at a specific environmental condition and may transform into another form in a period of time.

“Polymorph screening” means producing and identifying various polymorphs of a material.

“Desired substance” means The material comprised of one or more substances of interest.

“Enclosed Space” means a space enclosed by a metal or any other material.

“Antisolvent” means A fluid that acts as a nonsolvent to a substance and precipitates or crystallizes the substance.

“Compressed antisolvent” means an antisolvent at a compressed state, i.e. at a higher pressure than the atmospheric pressure.

“Crystal identification means” means techniques used to identify different crystal forms, structures or lack thereof. Present invention is not restricted by the type of the identification means. Any technique developed in the future can be used to practice the embodiments of the present invention. Typically, X-ray diffraction, differential scanning calorimetry, Raman spectroscopy, Infrared or near Infrared spectroscopy, thermal microscopy and others can be used for crystal identification.

“Crystal identification means transparent material” means A material that is amorphous or single crystalline so that it does not affect the crystal structure identification of another substance present in the containers made of the material. It may be an amorphous or single crystalline material where it's effects can be accounted for in crystal structure identification of the substance present in the container made of the material.

“Dispersion” means A homogeneous or heterogeneous mixture of the desired substance in one or more suitable solvents with or without dispersants.

Description

The present invention provides methods and apparatus for screening polymorphs of a variety of substances in a reasonably rapid way. It uses supercritical fluid technology as the basis for producing polymorphs. In this method, dispersions of a desired substance in various suitable solvents at various concentrations are prepared and transferred into several enclosed spaces which are capable of holding high pressures. A compressed antisolvent is added to the enclosed space either directly into the dispersion phase or above the dispersion phase at a controlled rate. Depending on the solvent, temperature, concentration of the dispersion, rate of addition of antisolvent to enclosed space and pressure inside the enclosed space, crystallization, or precipitation, of the desired substance can be varied. By controlling crystallization different polymorphs are formed.

Techniques such as infrared and raman spectroscopy, X-ray diffraction, rate of dissolution, atomic force microscopy, near or infra red spectroscopy, attenuated total reflected FTIR and differential scanning calorimetry (DSC) can be used to identify different crystalline forms. Once various polymorphs are generated, any of these methods can be subsequently used as an analytical tool.

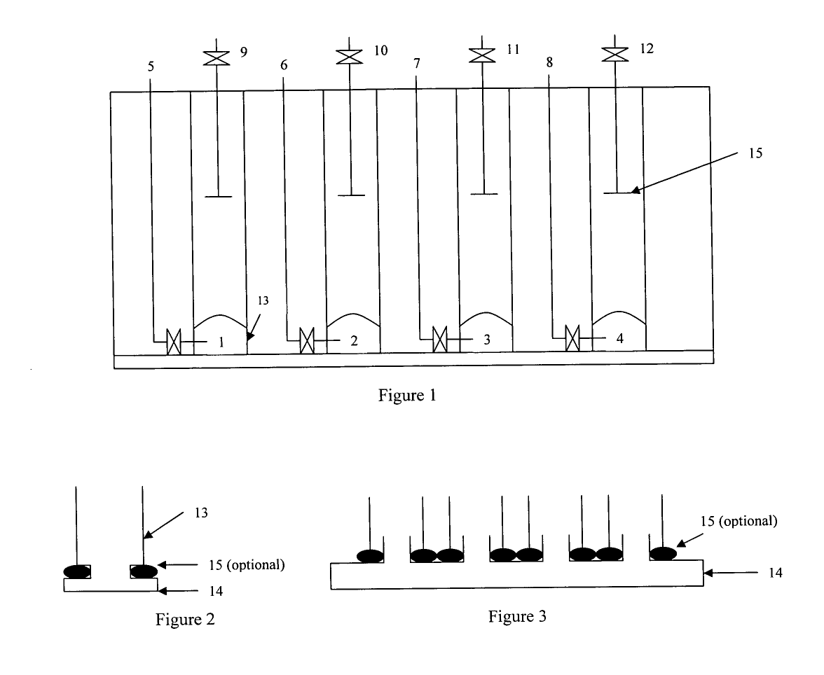

The volume of the enclosed spaces is chosen such that a given rate of addition of antisolvent can be achieved for a given amount of solution. FIG. 1 illustrates an embodiment of the present invention. For representative reason, 4 enclosed spaces are illustrated. It does not signify any limitation on the present invention. It can be 4, 8, 12, 96, 384, 864, 1536 or as many numbers as possible in any design. Typically it can be defined by the automation available in crystal structure identification means and its ability to handle as many samples in an automated fashion. Enclosed spaces 1, 2, 3, 4 are capable of holding pressures up to 30,000 psi, but preferably up to 10,000 psi. Antisolvent inlets 5, 6, 7, 8 are provided with a one way check valve to ensure no fluid is moved out of the enclosed space in those inlet lines. Outlets 9, 10, 11 and 12 are provided for the antisolvent/solvent mixture to exit the enclosed space. Filtering element 15 provides a way to retain the precipitates or crystallized material in the enclosed space. FIG. 2 illustrates how bottom cap 14 and enclosed space wall 13 are attached and sealed using a high pressure seal 15. A high pressure seal is optional if the bottom cap is pressure fitted to the vessel. FIG. 3 illustrates the same in a configuration with 4 enclosed spaces.

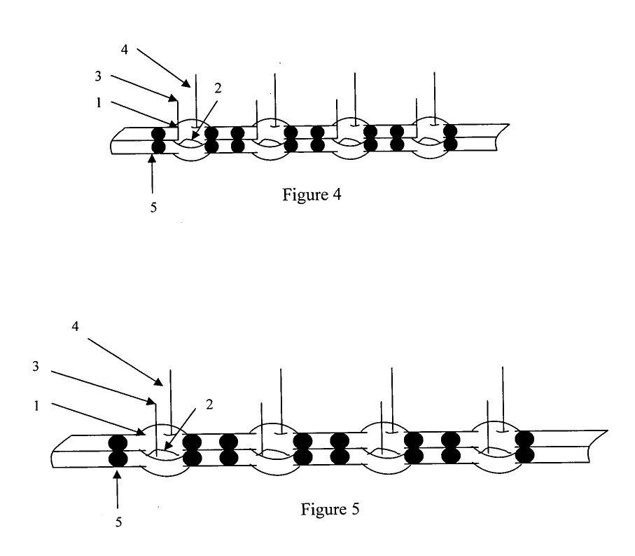

FIG. 4 illustrates an embodiment of the present invention in which the enclosed space can be in any shape. In a preferred embodiment, it is shown to be in close to spherical or spheroidal shape 1 with two split half spheres or spheroids pressed together with an optional high pressure seal. Precipitated or crystallized material can be either transferred to a well plate designed for crystal structure identification means or a well plate can be designed to fit in the bottom half of the spheroids. Spheroids are connected together forming a structure that can be described in laymen's terms similar to a grocery store egg container. Dispersion droplet 2 can be placed in the well plates prior to closing the spheroidal enclosed space by several dispensing means. Commercially available dispensers like ROBBINS® HYDRA® dispenser from Robbins Scientific Corporation, Sunnyvale. California can be used. The volume of the fluid can vary from fempto liter (1×10⁻¹⁵) quantities to milliliter quantities based on the dispensing means used and the availability of the dispersion. Certain solutes, for e.g. new drug candidates are very expensive and as a result very small quantities need to be used. In such situations dispensing means capable of dispensing fempto liters (1×10⁻¹⁵), pico liters (1×10⁻¹²) or nanoliters (1×10⁻⁹) quantities will be chosen. Antisolvent inlet 3 can add antisolvent directly into the dispersion droplet or just into the enclosed space. It has a check valve to ensure no reverse flow of any fluid. High pressure seal 5 seals the two spheroids or spheroids and the well plate element to ensure no fluid leaks out. Exit 4 is fitted with a filtering element to retain the precipitated or crystallized material inside the enclosed spaces. FIG. 5 illustrates an embodiment similar to the one in FIG. 4 except that the compressed antisolvent is added directly into the dispersion phase.

In another embodiment, after the dispersion is dispensed onto the bottom half-spheroids (or well plates) the enclosed spaces are closed and sealed. Compressed antisolvent is added at a controlled rate either into the enclosed space or directly inside the dispersion phase. Typically, slow additions increase the pressure inside the enclosed space slowly leading to slow saturation. At a pressure close to the cloud point of the system, precipitation/crystallization starts and pressure is further increased to a point where almost all the material is crystallized/precipitated as per the thermodynamics and kinetics of crystallization. After that, a valve in the exit line is opened and using a valve or a back pressure regulator, pressure is maintained at the same value while antisolvent is continuously added to and removed from the enclosed spaces. Antisolvent extracts the solvent from the droplet while simultaneously dissolving in the droplet expanding it and precipitating the desired substance. Solvent/antisolvent mixture exits the enclosed space through exit 4 while the precipitated or crystallized material is retained in the enclosed spaces.

In another embodiment of the present invention pressure of the enclosed spaces can be varied. Pressure can be varied before or during the application of the compressed antisolvent. Adding pressure at different times can also vary the crystallization parameters and lead to obtaining different polymorphs.

In another embodiment, provisions are provided for introducing agents enhancing or inducing the crystallization of dispersion droplets in the enclosed space. Amount of the enhancing agent or inducing agents can be varied depending on the nature of the system. Rate of addition of such agents can also be varied to vary the crystallization rate and obtain different polymorphs. Similarly, a small amount of a desired polymorph can be seeded around the time the dispersion starts crystallizing in the enclosed space. Such solid additions to a pressurized enclosed space may require some solid addition means.

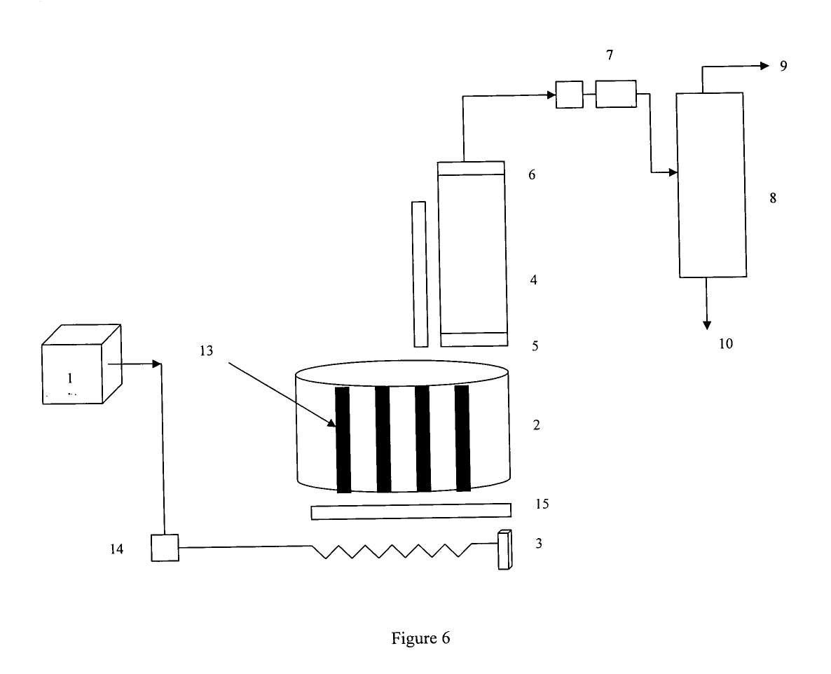

Another embodiment of the present invention is shown in FIG. 6. The system comprises high pressure pump 1 for pumping a compressed antisolvent. A plunger 3 is in fluidic communication with the compressed antisolvent. A plurality of enclosed spaces is provided in a circular carousel 2. An enclosed space 13 presented to the plunger 3 can be pushed from the carousel 2 by the plunger 3 into the chamber 4. The enclosed space 13 contains a filter with a check valve 5 at the inlet and another filter 6 at the outlet. The check valve ensures no dispersion flow back in to the compressed antisolvent addition line. Inside each enclosed space 13 will be a dispersion of a desired substance dissolved in a suitable solvent at a desired concentration. Once the enclosed space 13 is in chamber 4, compressed antisolvent is added to the enclosed space in a controlled manner increasing the pressure in the enclosed space 13 slowly. This results in crystallization of the dispersion in the enclosed space 13. Experimental conditions, such as dispersion concentration, pressure, temperature and compressed antisolvent addition rate will be varied in each enclosed space 13. Depending on the experimental conditions, different polymorphs can be formed. Once the polymorphs are formed as per the embodiments of the present invention in chamber 4, the compressed antisolvent, with the solvent will be carried out of the chamber 4, through a back pressure regulator (BPR) 7 into a cyclone separator 8 in which the compressed antisolvent will be vented off through the top 9 and the solvent will be removed at the bottom 10. The enclosed space 13 that is inside of the chamber 4 will be returned to its designated place in the carousel 2 and the carousel 2 will then rotate so as to allow another enclosed space 13 to be pushed into the chamber 4 by the plunger 3. The individual enclosed space 13 can then be removed from the carousel 2. The contents of 13 can be transferred to a crystal structure identification means. Such transfer can be accomplished after all the enclosed spaces were processed in chamber 4.

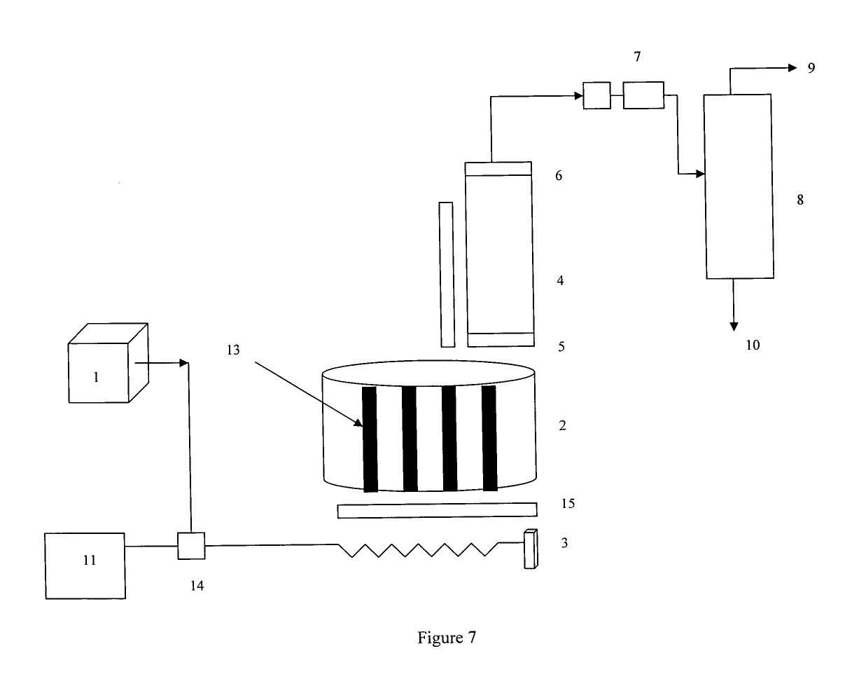

Another embodiment of the present invention is shown in FIG. 7. The system comprises high pressure pump 1 for pumping a compressed antisolvent. Another high pressure pump 11 to pump a co-antisolvent is also provided. A mixing tee 14 is provided so as to completely mix the compressed antisolvent and the co-antisolvent. A plunger 3 is in fluidic communication with the compressed antisolvent/co-antisolvent mixture. A plurality of enclosed spaces is provided in a circular carousel 2. An enclosed space 13 presented to the plunger 3 can be pushed from the carousel 2 by the plunger 3 into chamber 4. The enclosed space 13 contains a filter with a check valve 5 at the inlet and another filter 6 at the outlet. The check valve ensures no dispersion flow back in to the compressed antisolvent addition line. Inside each enclosed space 13 will be a dispersion of a desired substance dissolved in a suitable solvent at a desired concentration. Once the enclosed space 13 is in chamber 4, compressed antisolvent is added to the enclosed space in a controlled manner increasing the pressure in the enclosed space 13 slowly. This results in crystallization of the dispersion in the enclosed space 13. Experimental conditions, such as dispersion concentration, pressure, temperature and compressed antisolvent addition rate will be varied in each enclosed space 13. Depending on the experimental conditions, different polymorphs can be formed. Once the polymorphs are formed as per the embodiments of the present invention in chamber 4, the compressed antisolvent, with the solvent and co-antisolvent will be carried out of the chamber 4, through a back pressure regulator (BPR) 7 into a cyclone separator 8 in which the compressed antisolvent will be vented off through the top 9 and the solvent will be removed at the bottom 10. The enclosed space 13 that is inside of the chamber 4 will be returned to its designated place in the carousel 2 and the carousel 2 will then rotate so as to allow another enclosed space 13 to be pushed into the chamber 4 by the plunger 3. The individual enclosed space 13 can then be removed from the carousel 2. The contents of 13 can be transferred to a crystal structure identification means. Such transfer can be accomplished after all the enclosed spaces were processed in chamber 4.

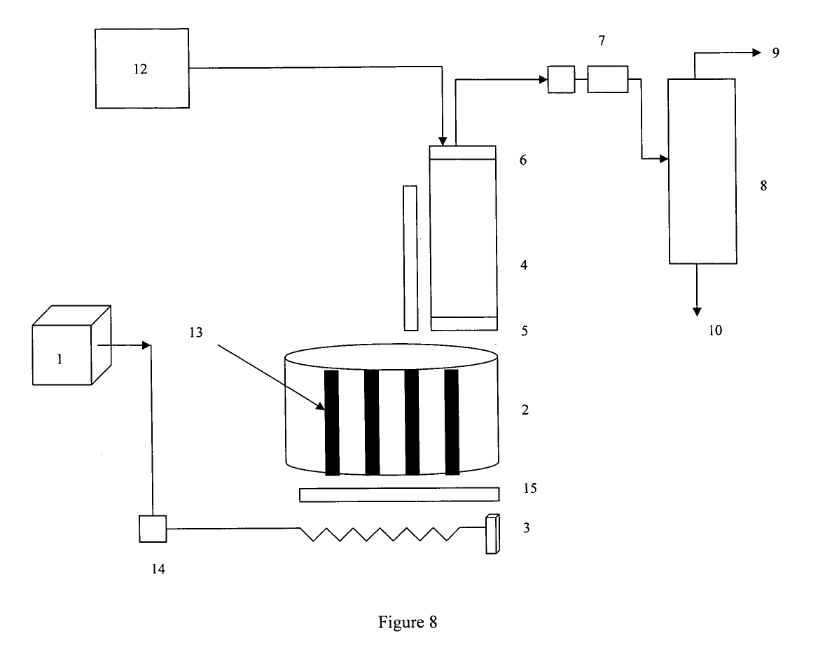

Another embodiment of the present invention is shown in FIG. 8. The system comprises a high pressure pump 1 for pumping a compressed antisolvent. A plunger 3 is in fluidic communication with the compressed antisolvent. An enclosed space 13 presented to the plunger 3 can be pushed from the carousel 2 by the plunger 3 into chamber 4. The enclosed space 13 contains a filter with a check valve 5 at the inlet and another filter 6 at the outlet. The check valve ensures no dispersion flow back in to the compressed antisolvent addition line. Once the enclosed space 13 is in chamber 4, compressed antisolvent is added to the enclosed space at a constant rate and the pressure of the enclosed space 13 is maintained at a constant pressure with the use of the back pressure regulator 7. Once the pressure and temperature are stabilized at the desired values, a dispensing means 12 transfers the dispersion containing desired substance in a suitable solvent directly into the enclosed space 13 which is inside the chamber 4. Appropriate fluidic connections are provided to accomplish this transfer. An optional dispersing means 16, such as a nozzle may be provided for dispersing the dispersion into the enclosed space 13. But, such dispersing means are not mandatory to practice the present invention. However, such dispersing means may provide for increased crystallization rate allowing some embodiments of the present invention practiced easily. The dispensing means 12 has the ability to vary properties such as dispersion concentration, dispersion addition rate and solvent type. The substance in the dispersion is crystallized and such crystals are retained inside the enclosed space 13 by the provided filters at the outlet end. The compressed antisolvent, with the solvent will be carried out of the enclosed space 4, through the back pressure regulator (BPR) 7 into a separator 8 in which the compressed antisolvent will be vented off through the top 9 and the solvent will be removed at the bottom 10. The enclosed space 13 that is inside of the chamber 4 will be returned to its designated place in the carousel 2 and the carousel 2 will then rotate so as to allow another enclosed space 13 to be pushed into the chamber 4 by the plunger 3. The individual enclosed space 13 can then be removed from the carousel 2. The contents of 13 can be transferred to a crystal structure identification means. Such transfer can be accomplished after all the enclosed spaces were processed in chamber 4.

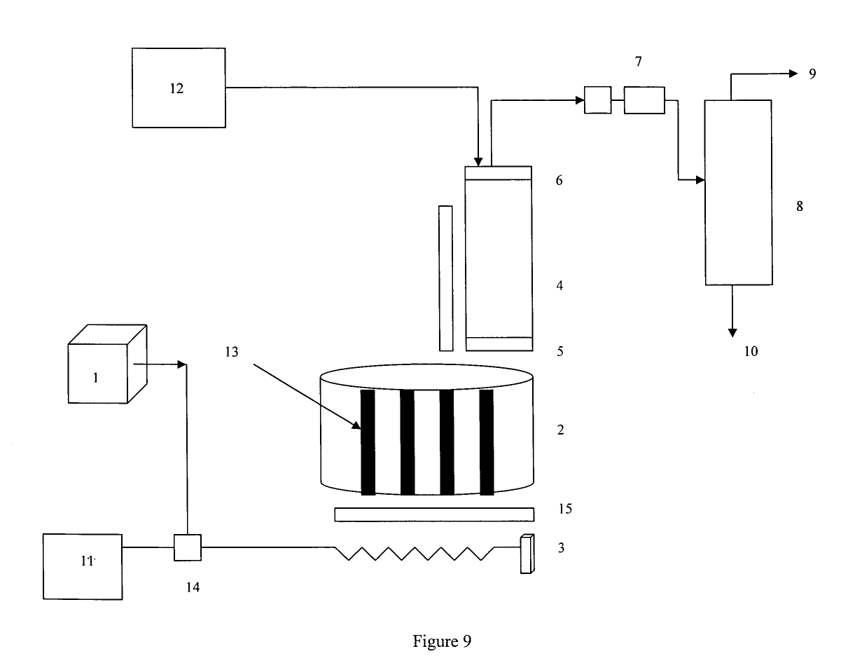

Another embodiment of the present invention is shown in FIG. 9. The system comprises a high pressure pump 1 for pumping a compressed antisolvent. Another high pressure pump 11 for pumping a co-antisolvent is also provided. A mixing tee 14 is provided so as to completely mix the compressed antisolvent and the co-antisolvent. A plunger 3 is in fluidic communication with the compressed antisolvent/co-antisolvent mixture. An enclosed space 13 presented to the plunger 3 can be pushed from the carousel 2 by the plunger 3 into chamber 4. The enclosed space 13 contains a filter with a check valve 5 at the inlet and another filter 6 at the outlet. The check valve ensures no dispersion flow back in to the compressed antisolvent addition line. Once the enclosed space 13 is in chamber 4, compressed antisolvent is added to the enclosed space at a constant rate and the pressure of the enclosed space 13 is maintained at a constant pressure with the use of the back pressure regulator 7. Once the pressure and temperature are stabilized at the desired values, a dispensing means 12 transfers the dispersion containing desired substance in a suitable solvent directly into the enclosed space 13 which is inside the chamber 4. Appropriate fluidic connections are provided to accomplish this transfer. An optional dispersing means 16, such as a nozzle may be provided for dispersing the dispersion into the enclosed space 13. But, such dispersing means are not mandatory to practice the present invention. However, such dispersing means may provide for increased crystallization rate allowing some embodiments of the present invention practiced easily. The dispensing means 12 has the ability to vary properties such as dispersion concentration, dispersion addition rate and solvent type. The substance in the dispersion is crystallized and such crystals are retained inside the enclosed space 13 by the provided filters at the outlet end. The compressed antisolvent, with the solvent will be carried out of the enclosed space 4, through the back pressure regulator (BPR) 7 into a separator 8 in which the compressed antisolvent will be vented off through the top 9 and the solvent will be removed at the bottom 10. The enclosed space 13 that is inside of the chamber 4 will be returned to its designated place in the carousel 2 and the carousel 2 will then rotate so as to allow another enclosed space 13 to be pushed into the chamber 4 by the plunger 3. The individual enclosed space 13 can then be removed from the carousel 2. The contents of 13 can be transferred to a crystal structure identification means. Such transfer can be accomplished after all the enclosed spaces were processed in chamber 4.

In another embodiment of the present invention, instead of a carousel 2 allowing for rotation of each extraction vessel 13, the carousel 2 may remain stationary and the chamber 4 will have the ability to rotate to each enclosed space 13. In another embodiment of the present invention, a collecting plate 15, can be placed beneath the carousel 2 in order to collect the polymorphs that are formed from each enclosed space 13 present in the carousel 2. Once all polymorphs are collected on the collecting plate 15, the collecting plate 15 can be transferred to crystal structure identification means.

The embodiments shown in FIG. 7 and FIG. 9 provide for co-antisolvent mixed with antisolvent. Such schemes are used when the solvent used is not directly substantially miscible with the antisolvent. For example, when water or any other polar solvents are used, co-antisolvent like ethanol or methanol can be used with carbon dioxide as the antisolvent. This is applicable to a large category of water soluble medicaments including proteins, peptides and water soluble salt forms such as albuterol sulfate. Typically, if an organic solvent is used, it may affect the secondary and tertiary structures of proteins. Such issues will be completely eliminated when water is used as per the embodiments of the present invention.

Another embodiment of the present invention is a system comprising a high pressure pump for pumping a compressed antisolvent. A plunger is in fluidic communication with the compressed antisolvent mixture. An enclosed space contains a filter with a check valve at the inlet and another filter at the outlet. The check valve ensures no dispersion flow back in to the compressed antisolvent addition line. Once the pressure and temperature are stabilized at the desired values, a dispensing means transfers the dispersion containing desired substance in a suitable solvent directly into the enclosed space which is inside a chamber. Appropriate fluidic connections are provided to accomplish this transfer. The dispensing means has the ability to vary properties such as dispersion concentration, dispersion addition rate and solvent type. The substance in the dispersion is crystallized and such crystals are retained inside the enclosed space by the provided filters at the outlet end. The compressed antisolvent, with the solvent will be carried out of the enclosed space, through a back pressure regulator (BPR) into a separator in which the compressed antisolvent will be vented off and the solvent will be removed at the bottom.

Crystal structure identification means may be broadly classified into visual analysis, microscopic analysis, thermal analysis, diffraction analysis and spectroscopic analysis. Any one or more than one of these techniques can be used to identify a crystal structure or a lack thereof. Visual analysis include observing it under different light sources. Microscopic analysis include scanning or tunneling electron microscopy, atomic force microscopy, thermal microscopy, optical microscopy etc. Thermal analysis include thermo gravimetric analysis, differential scanning calorimetry etc. Diffraction analysis includes X-ray diffraction, laser diffraction, dynamic laser diffraction etc. Spectroscopic techniques include near infrared spectroscopy, fourier transform infraraed spectroscopy, Attenuated total reflectance fourier tranform infrared spectroscopy, Nuclear magnetic resonance spectroscopy etc.

In another embodiment of the present invention, this portion cispersion inside the enclosed spaces can be pre-pressurized before the end anti-solvent is applied. In an additional embodiment, such a pre-pressurized system can be maintained at a constant pressure while the anti-solvent is being added by increasing the volume simultaneously. This allows the precipitation to take place at a constant pressure.

Various elements of the present invention can be practiced individually or in any combination thereof without any limitation. All elements disclosed in the present disclosure can be practiced within the context of various industries including but not limited to, fine chemicals, pharmaceuticals, nutraceuticals, coatings, and petrochemical industries.

The drawings in the present disclosure are referenced to the drawings in the provisional application, Ser. No. 60/467537.

The following example clearly illustrates the present invention:

### EXAMPLE 1

### Searching for and Generating Polymorphs of Sulfathiazole

Carbon dioxide was used as the antisolvent, and testing was carried out in an antisolvent system manufactured by Thar Technologies, Inc. The following table summarizes the temperature and solvent used in the design. This design of experiments utilized only one temperature, 100 bar, but pressure may be varied as a process parameter. Table 1 summarizes the temperatures and solvents used in this design of experiments.

| Experiment | Temp (C.) | Solvent |
|---|---|---|
| 1 | 35 | MeOH |
| 2 | 35 | Acetone |
| 3 | 61 | MeOH |
| 4 | 60 | MeOH |
| 5 | 35 | EtOH |
| 6 | 36 | EtOH |
| 7 | 49 | EtOH |
| 8 | 35.8 | EtOH |
| 9 | 36.2 | EtOH/H2O |
| 10 | 36.3 | 2-Propanol |
| 11 | 88.1 | 2-Propanol |
| 12 | 36.3 | 2-Propanol/EtOH |

The analysis was conducted by RJ Group (Monroeville, Pa.). A portion of each sample was loaded onto a zero background XRD holder for analysis. The samples were run using standard run parameters on a PANalytical X'Pert Pro XRD unit equipped with copper radiation. The following table presents thos results.

| Experiment | Polymorph |
|---|---|
| 1 | III Major, IV Major |
| 2 | III, Minor, IV Major |
| 3 | III Major |
| 4 | I Major, III Minor |
| 5 | I Trace, IV Major |
| 6 | II Trace, IV Major |
| 7 | II Minor, IV Major |
| 8 | I Major, III Minor, IV Minor |
| 9 | III Major, IV Minor |
| 10 | III Major, I Minor |
| 11 | I Major, IV Minor |
| 12 | I Minor, IV Major |

All of the four known polymorphs of the compound were found. The table below summarizes the polymorphs that were found and their respective concentration.

1. A method and apparatus for producing polymorphs of a desired substance comprising the steps of:
a. Providing a plurality of enclosed spaces
b. Transferring the dispersions of the desired substance in at least one solvent into different enclosed spaces; and
c. Applying a compressed antisolvent to the enclosed spaces to solidify the desired substance

2. The method and apparatus as in claim 1 wherein the temperature of the enclosed spaces can be controlled.

3. The method and apparatus as in claim 1, further comprising identifying the polymorphic form of the solidified substance using a crystal identification means.

4. The method and apparatus as in claim 1 wherein the dispersion is atomized in to the enclosed spaces.

5. The method and apparatus as in any one of the above claims wherein the transfer of dispersion and application of antisolvent are carried out simultaneously.

6. The method and apparatus as in claim 1 wherein the solvents are aqueous based.

7. The method and apparatus as in claim 1 wherein the solvents are organic based.

8. The method and apparatus as in claim 1 wherein the solvents are a combination of organic and aqueous based.

9. The method and apparatus as in claim 1 wherein the plurality of enclosed spaces is comprised of well plates.

10. The method and apparatus as in claim 1 wherein the plurality of enclosed spaces is comprised of a battery of high pressure vessels.

11. The method and apparatus as in claim 2 wherein the temperature is controlled through electric heaters.

12. The method and apparatus as in claim 2 wherein the temperature is controlled through magnetic heaters.

13. The method and apparatus as in claim 2 wherein the temperature is controlled through zone heaters.

14. The method and apparatus as in claim 1 wherein a means for controlling the rate of application of antisolvent is provided.

15. The method and apparatus as in claim 1 wherein the antisolvent is added directly into the dispersion phase.

16. The method and apparatus as in claim 1 wherein the pressure of the enclosed spaces can be varied.

17. The method and apparatus as in claim 16 wherein the pressure can be varied before applying the compressed antisolvent.

18. The method and apparatus as in claim 16 wherein the pressure can be varied while applying the compressed antisolvent.

19. The method and apparatus as in claim 1 wherein the antisolvent is selected as one or more combinations from a group consisting of methanol, ethanol, dimethylsulfoxide, tetrahydrofuran, N,N dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isbutyl acetate, isopropyl acetate, 2-methyl-1 propanol, pentane, 1-pentanol, 1-propanol, and 2-propanol, ethane, propane, carbon dioxide, nitrous oxide, butane, isobutene, sulfur hexafluoride.

20. The method and apparatus as in claim 1 wherein the antisolvent is carbon dioxide

21. The method and apparatus as in claim 1 wherein the antisolvent is a hydrofluorocarbon.

22. The method and apparatus as in claim 1 wherein the antisolvent is a chlorofluorocarbon.

23. The method and apparatus in claim 3 wherein the crystal structure identification means is X-ray diffractometry.

24. The method and apparatus in claim 3 wherein the crystal structure identification means is thermomicroscopy.

25. The method and apparatus in claim 3 wherein the crystal structure identification means is solid state nuclear magnetic resonance spectroscopy.

26. The method and apparatus in claim 3 wherein the crystal structure identification means is infrared or near infrared spectroscopy.

27. The method and apparatus in claim 3 wherein the crystal structure identification means is differential scanning calorimetry.

28. The method and apparatus in claim 3 wherein the crystal structure identification means is raman spectroscopy.

29. The method and apparatus in claim 1 wherein the bottom of the enclosed space holds the solidified material.

30. The method and apparatus in claim 1 wherein at least one side of the enclosed spaces is made of crystal identification means transparent material.

31. The method and apparatus as in claim 3 wherein the crystal structure identification is performed while the dispersion is solidified.

32. The method and apparatus as in claim 3 wherein the crystal structure identification is performed after the dispersion is solidified.

33. The method and apparatus as in claim 3 wherein the crystal structure identification is performed after the enclosed space is depressurized.

34. The method and apparatus as in claim 3 wherein the crystal structure identification is performed after the solids are removed from the enclosed space.

35. The method and apparatus as in claim 1 wherein transfer of dispersion is accomplished through a small dispensing means.

36. The method and apparatus as in 35 wherein the small dispensing means can handle microliter quantities.

37. The method and apparatus as in 35 wherein the small dispensing means can handle nanoliter quantities.

38. The method and apparatus as in 35 wherein the small dispensing means can handle picoliter quantities.

39. The method and apparatus as in 35 wherein the small dispensing means can handle femptoliter quantities.
